(19) United States
(12) Patent Application Publication
(10) Pub. No.: US 2014/0046765 A1
(43) Pub. Date: Feb. 13, 2014

(54) RICH MEDIA MOBILE ADVERTISING DEVELOPMENT PLATFORM

(71) Applicants: Matevz Klanjsek, Ljubljana (SI); Jaka Jancar, Ljubljana (SI); Aleksander Kmetec, Videm (SI); Mihael Mikek, Boston, MA (US)

(72) Inventors: Matevz Klanjsek, Ljubljana (SI); Jaka Jancar, Ljubljana (SI); Aleksander Kmetec, Videm (SI); Mihael Mikek, Boston, MA (US)

(73) Assignee: Celtra Inc., Cambridge, MA (US)

(21) Appl. No.: 13/464,107

(22) Filed: May 4, 2012

Related U.S. Application Data
(60) Provisional application No. 61/518,442, filed on May 5, 2011.

(51) Int. Cl. G06Q 30/02

(52) U.S. Cl. 705/14.64

(57) ABSTRACT

Some embodiments of the invention provide a mobile advertisement content development and management platform which may enable users without programming expertise to create mobile advertisement content suitable for display by, and distribution to, a wide variety of mobile devices and platforms. The platform may, for example, assist users with various aspects of creating rich media mobile advertisement content, associating a set of advertisements with one or more campaigns, managing ongoing campaigns, and/or measuring the effectiveness of campaigns and individual mobile advertisements.

### RELATED APPLICATIONS

This application claims priority under 35 U.S.C. §119(e) to U.S. Provisional Patent Application Ser. No. 61/518,442, entitled “RICH MEDIA MOBILE ADVERTISING DEVELOPMENT PLATFORM,” filed on May 5, 2011, the entirety of which is incorporated herein by reference.

### FIELD

This invention relates to mobile advertising, and more particularly to tools used to develop and manage mobile advertisement content and campaigns.

### BACKGROUND

A mobile advertisement is one which is designed for display on a mobile device (e.g., a handheld device such as a smartphone, a tablet computer, a dashtop device such as a GPS navigation device, a satellite radio receiver, a mobile payment platform, a content reproduction device such as an MP3 player, a video game console, or any other type of portable device). A mobile advertisement is often presented to a viewer on a mobile webpage (i.e., by a browser executing on the mobile device) or within a mobile application (i.e., “in-app,” by an application, such as a native application, executed by the mobile device).

Mobile advertisements may take any of numerous forms. Example types of mobile advertisements include banner ads (which may be shown to a viewer at the top or bottom of his/her mobile device's display screen), expandable banner ads (which expand from a banner at the top or bottom to occupy a larger portion of the screen), interstitial ads (which are typically presented “between” pages of a mobile web site, while the content of a target web page to which a viewer desires to navigate loads), and other types.

A growing trend in mobile advertisement is the inclusion of so-called “rich media” in advertisements, which may comprise content and components designed to offer a more sophisticated user experience than prior mobile advertisements afforded. For example, rich media mobile advertisements may include animated content, one or more components with which a viewer may interact, and other content types designed to engage the user, such as by providing games or other types of interactive experiences.

### SUMMARY

The inventors have appreciated that conventional tools for developing mobile advertisement content often require users to possess knowledge of one or more programming languages, especially to produce mobile advertisements which include customized elements. For example, while some conventional content development tools may assist with the creation of basic hypertext markup language (HTML) content, adjustments to the code to create content that produces an engaging, interactive experience for the viewer typically requires the user to possess programming expertise, which many creators of mobile advertising content lack.

The inventors have also appreciated that diversity among the types of devices and device platforms on which a mobile advertisement may execute, and the types of trafficking techniques that may be used to distribute a mobile advertisement, poses barriers to content development and delivery. In this respect, developing mobile advertisement content which is “agnostic” in the sense that each target recipient mobile device has the capability (e.g., the screen resolution, computing resources, network connectivity, etc.) to display it as designed, which will execute properly under specified mobile operating systems, and which prevalent distribution systems will be capable of handling without issue, is challenging. However, advertisers, advertising agencies and other entities that develop and/or distribute content rightfully expect that that a content development tool generates content having these characteristics.

Some embodiments of the present invention provide a mobile advertisement content development and management platform which allows a user to create mobile advertising content suitable for display by, and distribution to, a wide variety of mobile devices without requiring the user to possess programming and/or other technical expertise. For example, some embodiments of the invention provide a platform for creating rich media mobile advertisements, grouping a set of mobile advertisements into a campaign, managing one or more campaigns, and measuring the effectiveness of each of those campaigns. In some embodiments, the content development and management platform includes a “dashboard” which enables the user to manage previously created campaigns, an “ad builder” for generating mobile advertisement content, an “analytics” module for analyzing the effectiveness of mobile advertisement campaigns, and a “tag generator” to create HTML tags to accomplish mobile advertisement distribution.

In some embodiments of the invention, the platform provides a graphical interface with which a user may create customized, engaging and interactive mobile advertisement content for consumption by a viewer. By providing a graphical interface with which a user may define content behavior, embodiments of the invention may remove the need for the user to possess programming expertise, as previous tools required. Via the graphical interface, a user may define actions to be performed by, and/or in relation to, items of content in a mobile advertisement, such as actions to be performed upon the occurrence of an event (e.g., relating to the display of the mobile advertisement by a device and/or receipt of input to the mobile device on which the content is shown), so that users may develop mobile advertisement content which provides a sophisticated viewer experience, without needing programming and/or other technical skills to do so.

In some embodiments of the invention, the platform may enable a user to include predefined “components,” or “widgets,” in a mobile advertisement, and to link the execution of two or more components through the occurrence of an event or the performance of an action. As such, an event or action which occurs in relation to one component may affect how another component displays information. This capability may enable users to create mobile advertising content which provides a sophisticated experience for the viewer, like games or other types of interactive activities.

Some embodiments of the invention allow a user to define a sequence of actions to be performed by one or more items of content in a mobile advertisement without reference to a timeline. For example, in some embodiments, a user may define the performance of one action in relation to the performance of one or more other actions, rather than at a particular point in time on a timeline. As previous tools and approaches required users to programmatically define the manner in which actions are performed, embodiments of the present invention may enable rich media mobile advertising content to be developed much more quickly and easily than conventional tools and approaches allow.

A content development and management platform implemented in accordance with some embodiments of the invention may guide a user through the creation of mobile advertisement content which has characteristics that allow the content to be displayed properly by any of a variety of mobile devices, to be executed by any of a variety of mobile operating systems, and to be distributed via any of a variety of trafficking techniques and systems. In some embodiments, the content development and management platform may define and/or impose one or more rules, and/or make one or more recommendations to the user, relating to a mobile advertisement's size, content, and/or other characteristics, given a set of one or more target devices, platforms and/or trafficking techniques. As such, some embodiments of the invention may enable of creation of mobile advertising content which is agnostic in that it may be displayed properly on a wide variety of devices, execute properly under a wide variety of mobile operating systems, and may be distributed properly using a wide variety of publisher environments.

In some embodiments, the platform provides an interface which may enable a user to define a manner in which mobile advertisement content is displayed on a device when a viewer of the advertisement changes the orientation of the device. In this respect, conventional content development platforms either do not allow the user to define this behavior, or do not provide for a mobile advertisement to be displayed differently when the device's orientation is changed. Some embodiments of the invention, by contrast, enable a mobile advertisement to be re-sized, cropped in a user-specified manner, and/or set to scroll in a user-specified manner when a device is re-oriented by a viewer.

In some embodiments, a content development and management platform provides an interface which may enable a user to define characteristics of a mobile advertisement for display in a particular runtime environment which imposes limitations on the characteristics of the mobile advertisement. A facility may, for example, ensure that mobile advertisement content created by the user accommodates those limitations. For example, if a particular runtime environment imposes a predefined “close” button on all mobile advertisements, then the facility may restrict a user from specifying a customized close button, and/or take other steps to ensure that limitations imposed by the runtime environment are accommodated.

In some embodiments, a content development and management platform may generate code representing a mobile advertisement in a form which makes issue-free distribution and display more likely. For example, in some embodiments, a content development and management platform may be configured to generate code (e.g., HTML5 code) which includes the content of a mobile advertisement in an “image” tag. As a result of the content being included within the image tag, web sites which serve the advertisement treat it as an image, which can help ensure that it is displayed by the web site properly.

It should be appreciated that the foregoing is a non-limiting summary of some aspects of the invention, which are defined by the attached claims.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a flowchart depicting an example process for providing a graphical interface enabling the creation of mobile advertising content, in accordance with some embodiments of the invention;

FIGS. 2-8 depict example screen interfaces which may enable a user to define content of a mobile advertisement, in accordance with some embodiments of the invention;

FIG. 9 is a flowchart depicting an example process whereby components employed in a mobile advertisement may be linked via one or more events and/or actions, in accordance with some embodiments of the invention;

FIGS. 10-11 depict example screen interfaces which may enable a user to link one or more components via one or more events and/or actions, in accordance with some embodiments of the invention;

FIG. 12 is a flowchart depicting an example process for defining a sequence of actions, to be performed in relation to items of content included in a mobile advertisement, without reference to a timeline, in accordance with some embodiments of the invention;

FIG. 13 depicts an example screen interface portion with which a user may define a sequence of actions without reference to a timeline, in accordance with some embodiments of the invention;

FIG. 14 is s flowchart depicting an example process whereby an interface is provided which may guide a user in creating mobile advertisement content having certain characteristics, in accordance with some embodiments of the invention;

FIG. 15 depicts example screen interface portions which may guide a user through creation of mobile advertisement content having certain characteristics, in accordance with some embodiments of the invention;

FIG. 16 is a flowchart depicting an example process for enabling a user to define the behavior of a mobile advertisement when a viewer changes the orientation of a device on which the mobile advertisement is displayed, in accordance with some embodiments of the invention;

FIG. 17 depicts example screen interface portions with which a user may define the behavior of a mobile advertisement upon a viewer changing the orientation of a device on which the mobile advertisement is displayed, in accordance with some embodiments of the invention;

FIG. 18 is a flowchart depicting an example process for providing an interface which enables a user to define a mobile advertisement for display in a particular runtime environment, in accordance with some embodiments of the invention; and

FIG. 19 depicts example screen interface portions which may enable a user to define a mobile advertisement for display in a particular runtime environment, in accordance with some embodiments of the invention.

### DETAILED DESCRIPTION

Some embodiments of the present invention provide a mobile advertisement content development and management platform that enables users who may not have programming or other technical expertise to create mobile advertising content suitable for display by, and distribution to, a wide variety of mobile devices and platforms. In some embodiments, the content development and management platform may enable users to create rich media mobile advertisements, associate a set of advertisements with one or more campaigns, manage ongoing campaigns, and/or measure the effectiveness of campaigns and individual mobile advertisements. In some embodiments, the platform includes a “dashboard” that enables the user to manage mobile advertisements and advertising campaigns, an “ad builder” for generating content of a mobile advertisement, an “analytics” module for analyzing the effectiveness of mobile advertisements and/or campaigns, and a “tag generator” for generating code enabling mobile advertisement distribution.

In some embodiments, the “ad builder” of the content development and management platform provides a graphical interface which enables a user to employ one or more items of content (e.g. images, logos, backgrounds, and/or other content items) to create a customized, engaging and interactive mobile advertisement. The graphical interface may enable the user to define the behavior of items of content within the mobile advertisement, such as one or more actions to be performed by, or in relation to, one or more items of content. An action may, for example, be performed upon the occurrence of a user-specified event. An event may relate to display of the mobile advertisement by a particular device (e.g., the advertisement's initial appearance on the device's display) and/or input received by the mobile device (e.g., a “tap,” “swipe,” and/or other form(s) of input, including touch input and other forms of input including voice). By providing a graphical interface for developing rich media mobile advertisement content, embodiments of the invention allow users without programming and/or other technical skills to create a sophisticated experience for the viewer.

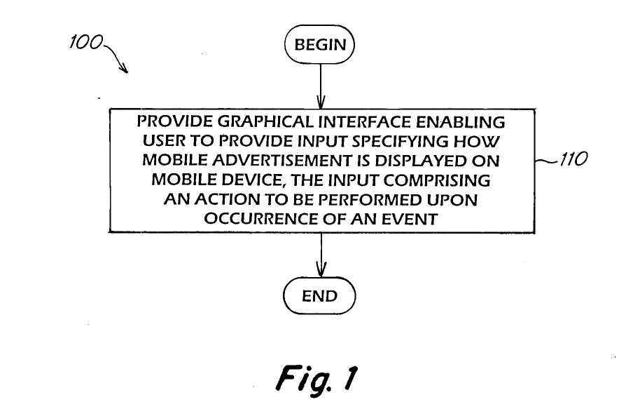

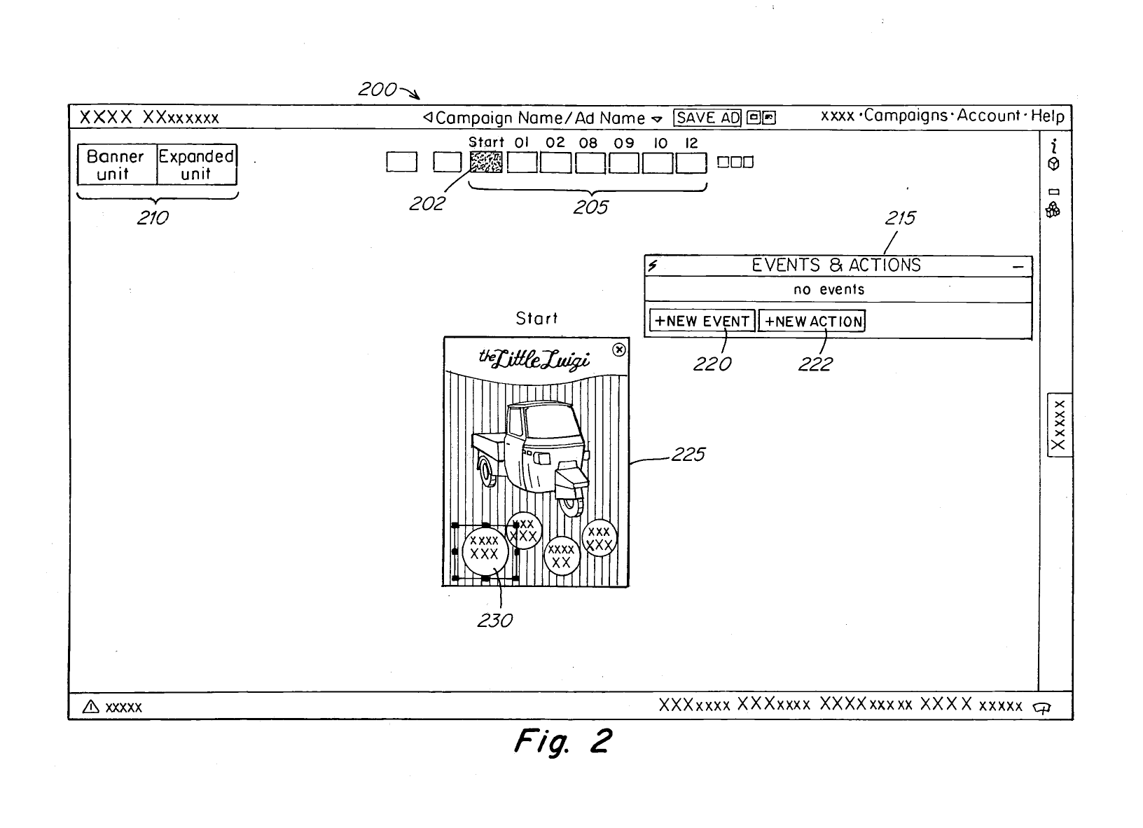

FIG. 1 depicts an example process 100 which may be performed by a content development and management platform implemented in accordance with embodiments of the invention. At the start of example process 100, in act 110, a graphical interface is provided which enables a user to provide input specifying how a mobile advertisement is displayed on a mobile device, wherein the input comprises an action that at least one item of content included in the mobile advertisement is to perform upon the occurrence of an event, and wherein the event relates to display of the mobile advertisement by a mobile device, and/or input received to the device. This may be performed in any of numerous ways. One example of a graphical interface which may enable a user to define actions to be performed in relation to items of content within a mobile advertisement, such as upon the occurrence of an event, is shown in FIG. 2.

Example graphical interface 200 which is shown in FIG. 2 includes various controls which relate to development of content for a mobile advertisement. For example, example graphical interface 200 includes page control 205, which enables a user to select a particular page of a mobile advertisement for viewing and/or modification. In the example shown in FIG. 2, the user has selected page 202, causing mobile advertisement page 225 to be displayed. Mobile advertisement page 225 includes item of content 230.

Example graphical interface 200 includes version control 210 which, when a particular advertisement page is selected (in this example, mobile advertisement page 225), enables the user to select a version of the page for display. In the example shown, a user may select from among a “banner unit” version and an “expanded unit” version, although any of numerous version types may be supported. In example graphical interface 200, the user has specified that an expanded unit version of a particular mobile advertisement is to be shown, as indicated by the “expanded unit” portion of version control 210 being shaded.

Example graphical interface 200 includes events and actions control 215, which enables a user to specify one or more events (e.g., relating to the display of the mobile advertisement by a device, input received to the device, and/or an absence of input to the device (e.g., over a specified time period)). An event may, for example, relate to the mobile advertisement page overall, or a particular items of content shown on the page (e.g., item 230). Events and actions control 215 may also enable the user to define one or more actions to be performed by, or in relation to, one or more items of content (e.g., upon the occurrence of one or more specified events). In example graphical interface 200 shown in FIG. 2, a user may specify an event by clicking control 220, and an action by clicking on control 222.

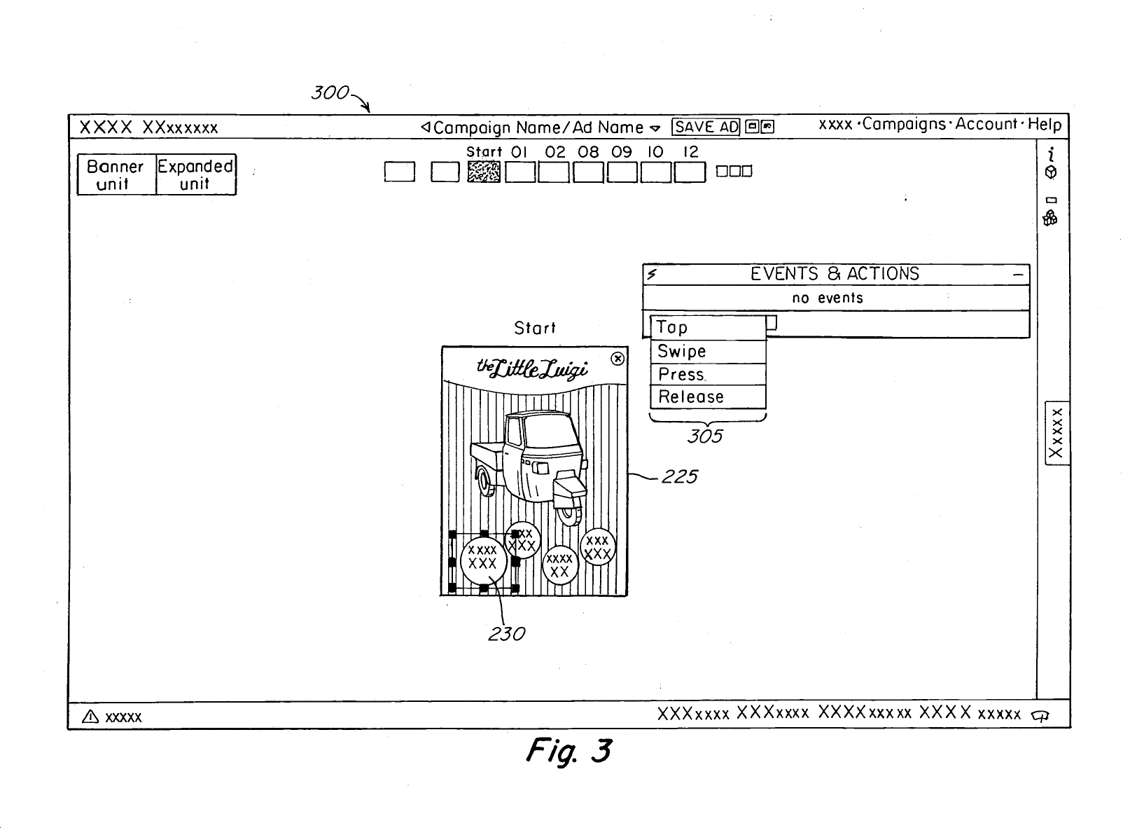

FIG. 3 depicts example graphical interface 300, which is displayed when the user selects item 230 (as indicated by the box surrounding it) and indicates via control 220 (shown in FIG. 2) that a new event is to be specified in relation to item 230. Clicking on control 220 causes menu 305 to be displayed, from which the user may select from menu options including “tap,” “swipe,” “press,” and “release,” as shown in FIG. 3. In the example shown, the “tap” option is selected, indicating the user has specified an event of a tap input being received to item 230 on the mobile advertisement.

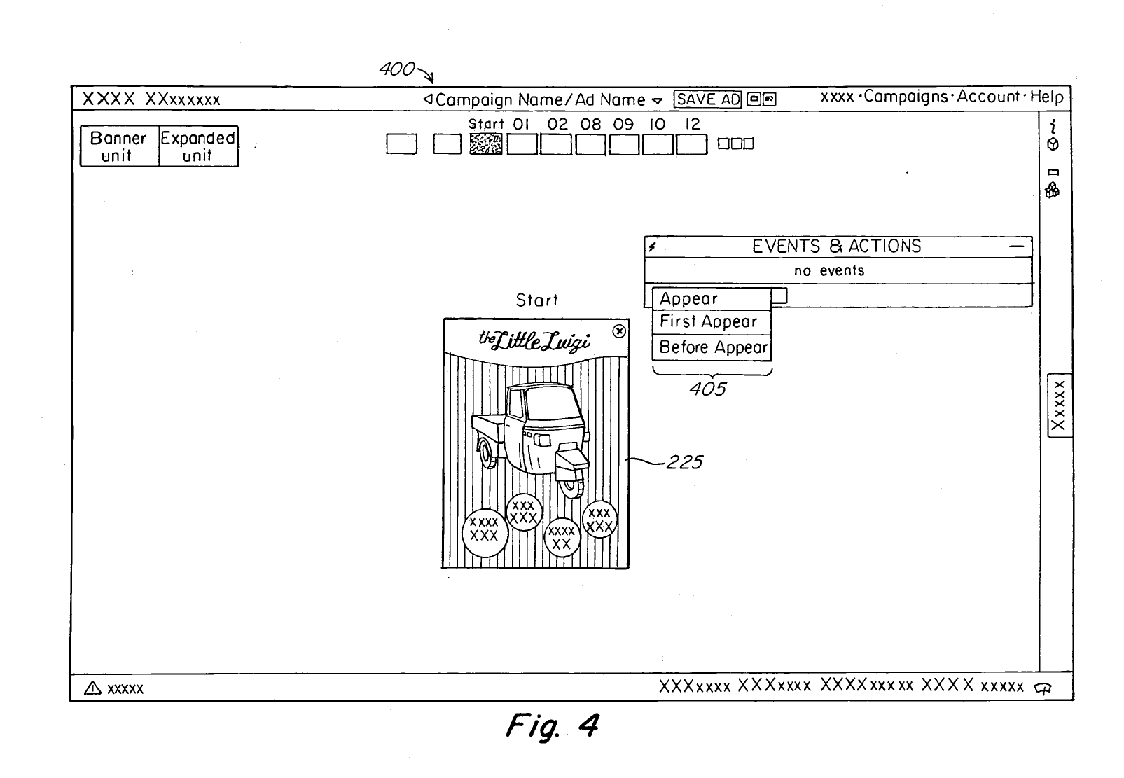

As noted above, an event may relate to a page overall, rather than to a particular item of content on the page. FIG. 4 shows an example graphical interface 200 which is displayed when no item of content is selected and the user indicates via control 220 that an event is to be created. In the example of FIG. 4, this causes menu 405 to appear, which includes options including “appear,” “first appear,” and “before appear.” In the example shown, the user has selected the “appear” option, thereby defining an event of page 225 appearing.

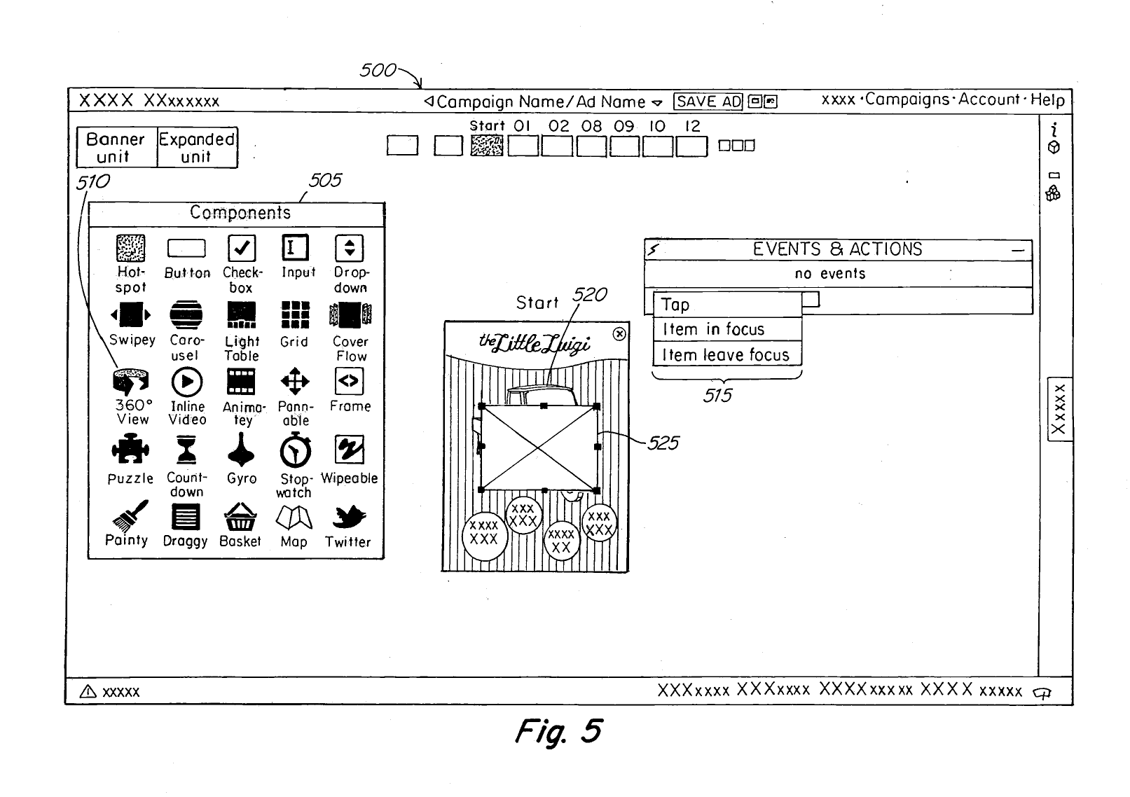

In addition to a page and an item of content, an event can also be defined in relation to a “component” included in a mobile advertisement. In this respect, a content development and management platform implemented in accordance with some embodiments of the invention may provide a set of predefined components, which may be included in a mobile advertisement, and which may provide pre-programmed functionality. For example, FIG. 5 depicts example interface 500, which includes twenty-five example components shown in menu 505. Of course, any suitable number of components, each of which may provide any suitable functionality, may be provided by a content development platform, as embodiments of the invention are not limited in this respect.

In the example shown in FIG. 5, the user has selected component 510 from menu 505. Component 510 provides a 360° view of an image to which the component refers (in the example shown, image 520, as indicated by box 525). By clicking on event control 220 (shown in FIG. 2), the user may specify an event in relation to this component. Specifically, doing so causes menu 515 to appear, which includes menu options “tap,” “item in focus,” and “item lead focus.” In the example shown, the user has selected the “tap” menu option, indicating that the event is that a tap input is received to the image to which the component refers.

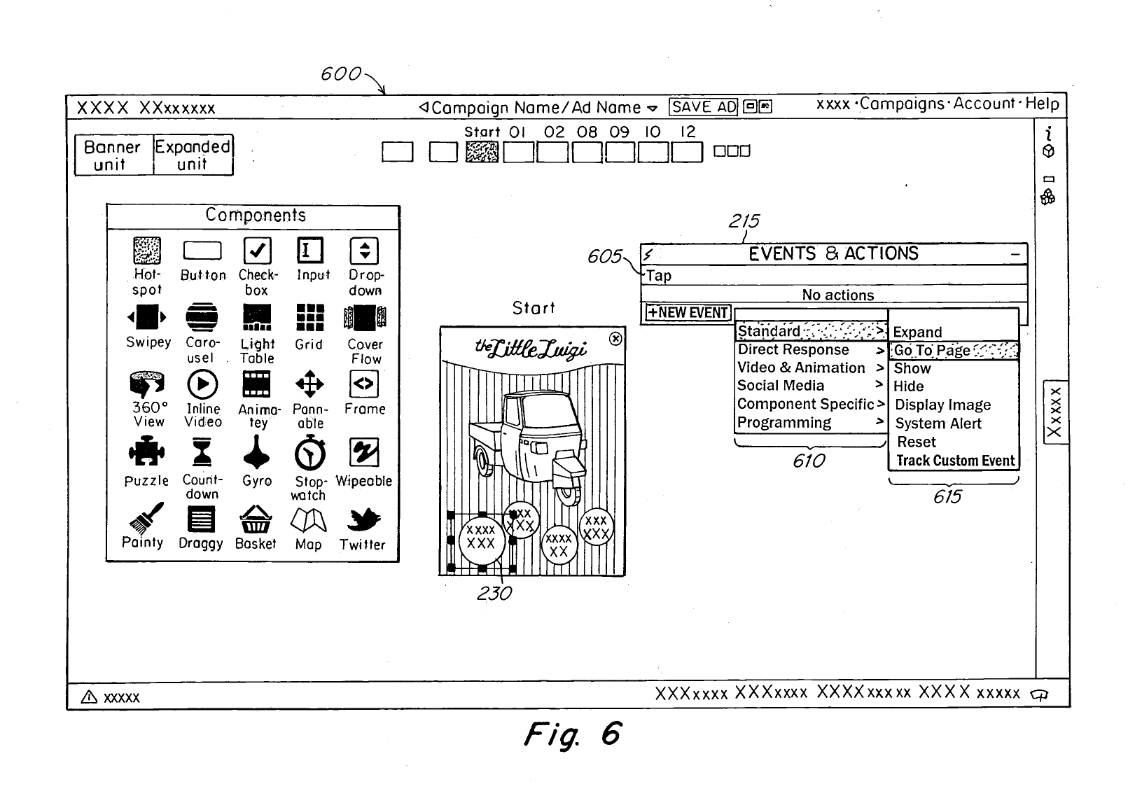

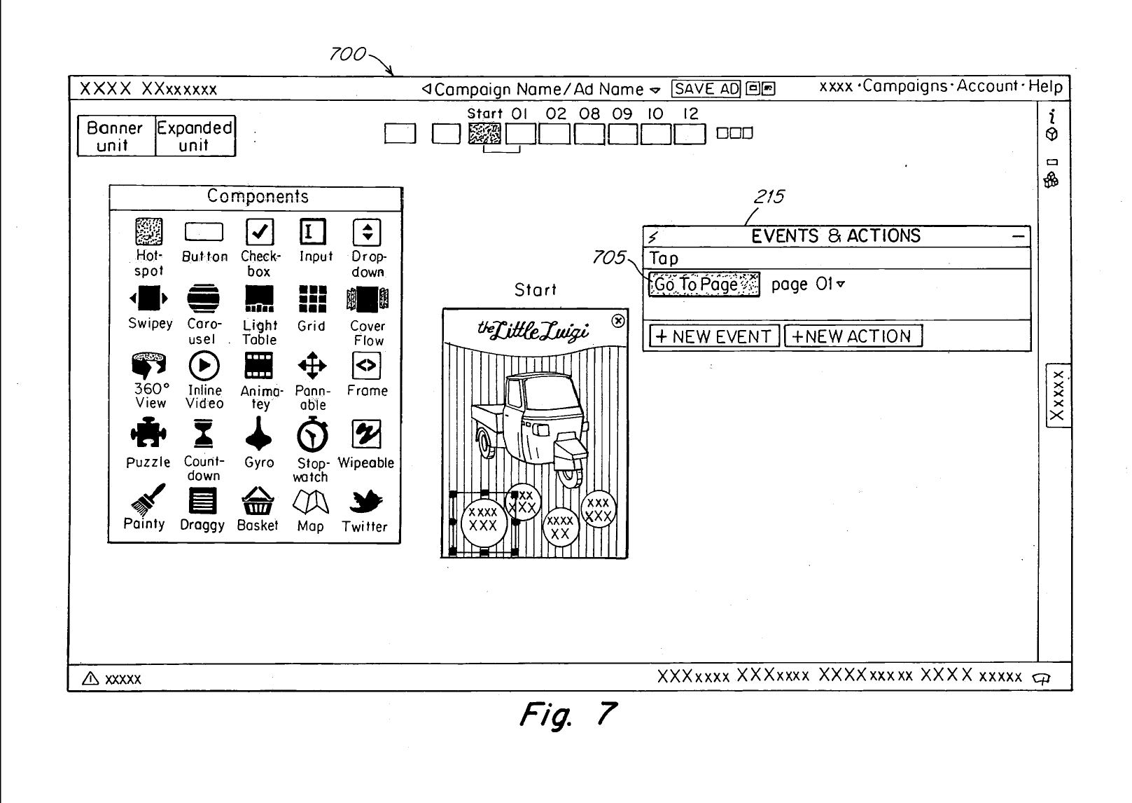

As noted above, the user may specify that one or more actions be performed upon the occurrence of one or more events. Example interface 600, shown in FIG. 6, depicts the creation of an action to be performed upon the occurrence of event specified in relation to item 230. Specifically, selecting item 230 (for which a “tap” event was created in the example described above in relation to FIG. 3, as shown by portion 605) and then clicking on control 222 (FIG. 3), causes menu 610 to be shown in the example interface 600 shown in FIG. 6. In the example shown, the user has selected the “standard” menu option, causing menu 615 to be displayed. From menu 615, the user has selected menu option “go to page.” As such, the user specifies that upon a tap to item 230 being detected, the viewer is to be taken to a particular web page. In example interface 700, shown in FIG. 7, portion 705 of menu 215 indicates that this action has been saved in relation to mobile advertisement being created.

It should be appreciated that the types of actions that may be defined are not limited to those indicated by the menu options shown in the example interfaces described herein. Any of numerous types of actions may be defined for inclusion in a mobile advertisement. Embodiments of the invention are not limited to any particular manner of implementation.

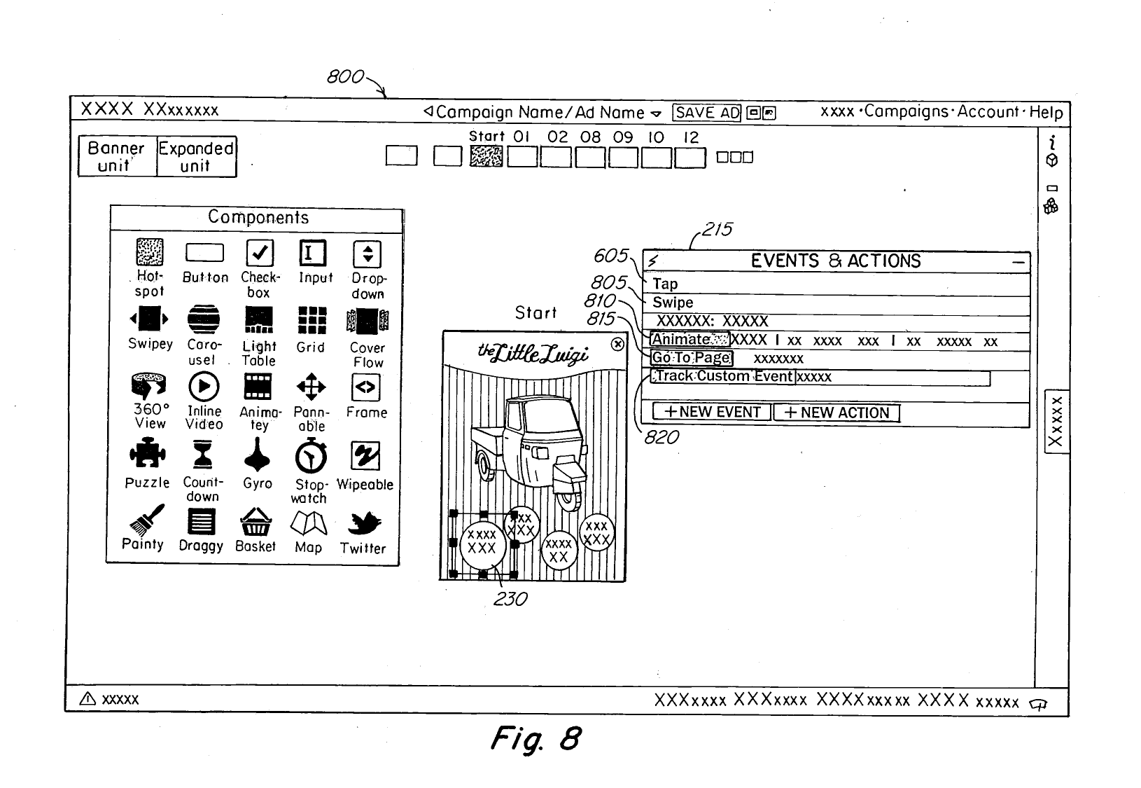

It should also be appreciated that any suitable number of events may be specified in relation to a particular page, element or component, and that more than one action may be specified to be performed upon the occurrence of an event. In this respect, the example interface 800 depicted in FIG. 8 shows a user specifying multiple actions to be performed upon the occurrence of a particular event. Specifically, upon the occurrence of a “swipe” event (as reflected by portion 805 of menu 215) in relation to item 230, the user has specified that an “animate” (reflected via indicator 810) action and a “go to page” action (reflected via indicator 815) be performed. Any suitable number of actions may be specified, whether or not in relation to a particular event, as embodiments of the invention are not limited in this respect.

It should be further appreciated that with conventional tools and approaches, to define one or more actions to be performed by one or more items of content included in a mobile advertisement, a user would write program code specifying the action(s), and thus would have to have programming and/or other technical skills. By contrast, embodiments of the invention provide a graphical interface which enables a user without programming and/or other technical skills to quickly and easily create sophisticated, rich media mobile advertisement content.

In some embodiments, a content development and management platform implemented in accordance with embodiments of the invention may enable a user to link components deployed within a mobile advertisement via an event or action. As a result, the occurrence of an event or performance of an action in relation to one component may affect the behavior of another component, producing an engaging experience for the viewer which conventional tools and approaches are not equipped to provide.

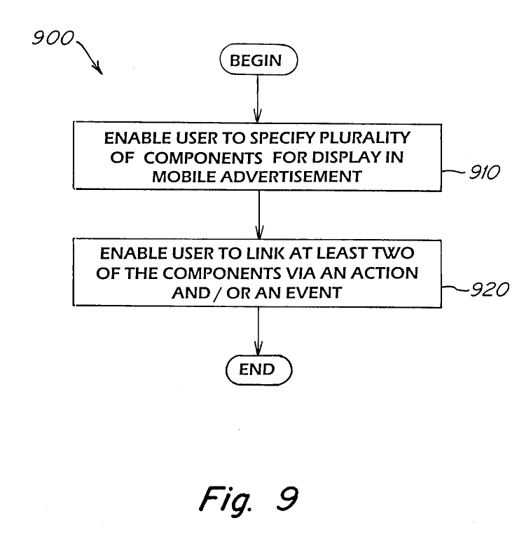

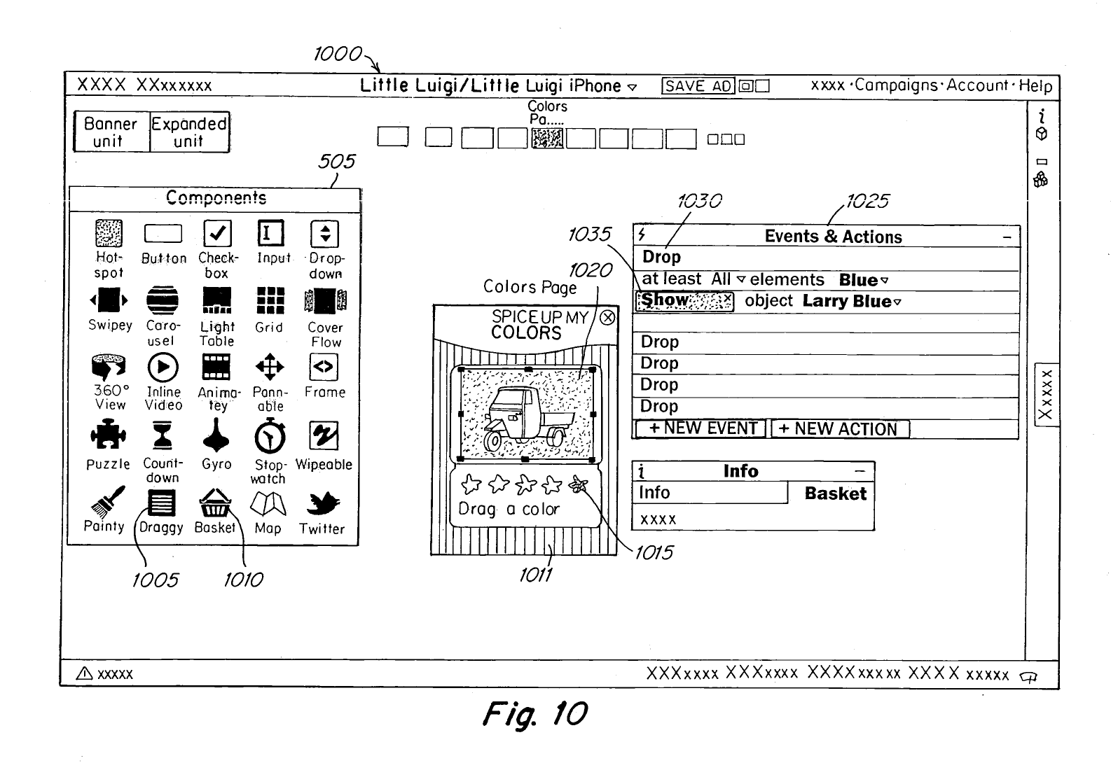

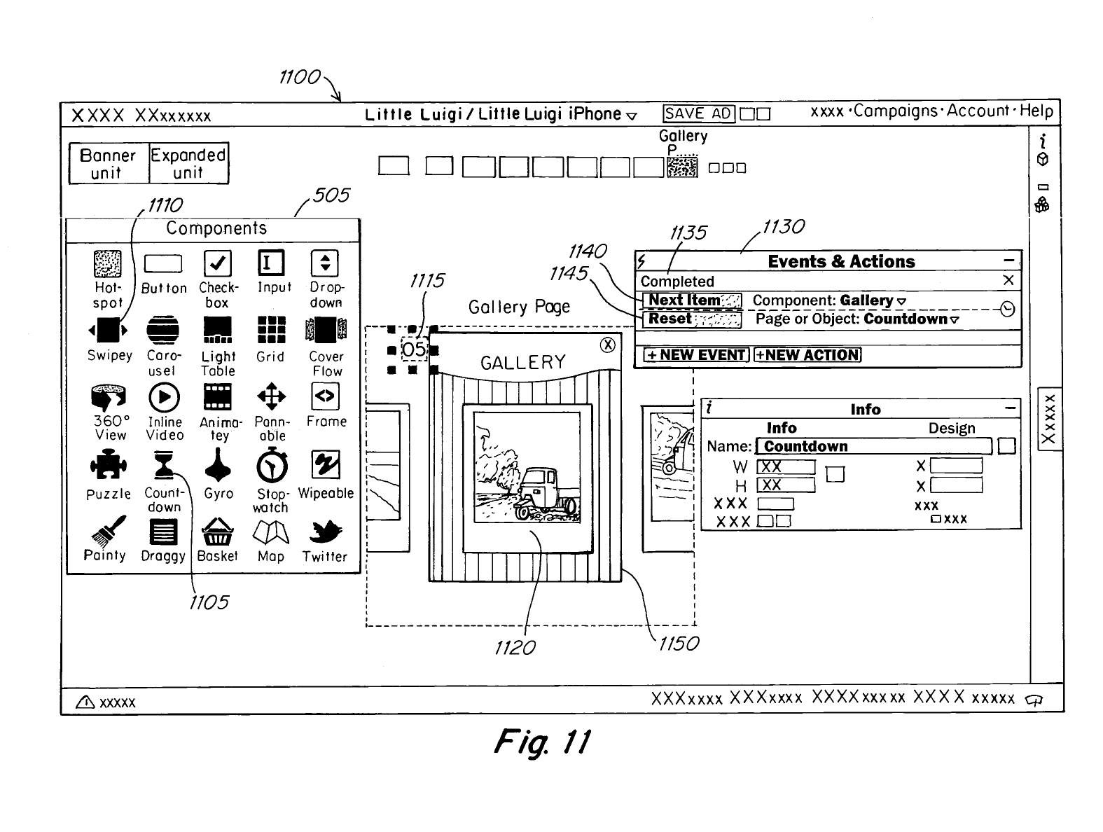

An example process 900 which may be performed by a content development and management platform to enable components to be linked via an event and/or action is shown in FIG. 9. At the start of example process 900, a user is enabled to specify a plurality of components for display in a mobile advertisement in act 910. This may be performed in any of numerous ways. For example, the example interface 1000 shown in FIG. 10 includes menu 505 which includes twenty-five example components that may be included in a mobile advertisement. In the example shown in FIG. 10, the user has chosen menu options 1005 (“Draggy”) and 1010 (“Basket”) for inclusion within example page 1011, displayed on page 1011 as components 1015 and 1020, respectively.

Example process 900 then proceeds to act 920, wherein a user is enabled to link at least two of the plurality of components via an event and/or action. This, also, may be performed in any of numerous ways. In the example which is given herein, the user may specify that an event occurring in relation to component 1015 (in this example, dragging and dropping a color into the display area occupied by component 1020) is to cause the behavior of component 1020 (in this example, the color of the image displayed by component 1020) to change. This is accomplished using options provided by menu 1025. In the example shown, the user has indicated that upon the occurrence of a “drop” event (as reflected at portion 1030 of menu 1025) of the “Blue” element within component 10105, a “show” action (as reflected at portion 1035) is to be performed, to change the color of the image displayed in component 1020 to the color “Larry Blue.” Of course, any suitable number of events and/or actions may be used to link any suitable number of components, as the example given above is intended to merely be illustrative.

For example, an event which links two components need to involve any user input being received. For example, in the example interface 1100 depicted in FIG. 11, the user has selected component menu options 1105 (“Countdown”) and 1110 (“Swipey”), shown on page 1150 as components 1115 and 1120, respectively. In this example, component 1115 counts down from a specified starting point without user input, and component 1120 switches among a collection of images. In the example shown, the user has linked components 1115 and 1120 by specifying that upon the occurrence of a “completed” event (as reflected at portion 1135) in relation to countdown component 1115 (as indicated by the box surrounding component 1115), a “next item” action is to be performed in relation to component 1120 (as reflected at portion 1140), and that a “reset” action is performed in relation to component 1115 (i.e. as reflected at portion 1145). As such, when the countdown performed by component 1115 completes, a next image in a gallery of images is displayed by component 1120, and the countdown starting point of component 1115 resets, thereby enabling each image to be displayed for a set period of time before a new image is shown.

The uses given above of one or more actions or events to link components represent mere illustrative, but non-limiting examples. Embodiments of the invention may enable any suitable number and/or types of components to be linked via any suitable number and type of event(s) and/or action(s). Further, the occurrence of an event or performance of an action in relation to one component may affect the behavior of another component in any of numerous ways. For example, the occurrence of an event or performance of an action in relation to one component may cause information displayed by another component to change, cause another component to start or stop performing one or more functions, cause another component to cease responding to user input, and/or to affect the behavior of another component in one or more other ways. By linking components via events and/or actions, some embodiments of the invention may enable the creation of sophisticated, engaging content, by users who do not possess programming and/or other technical skills.

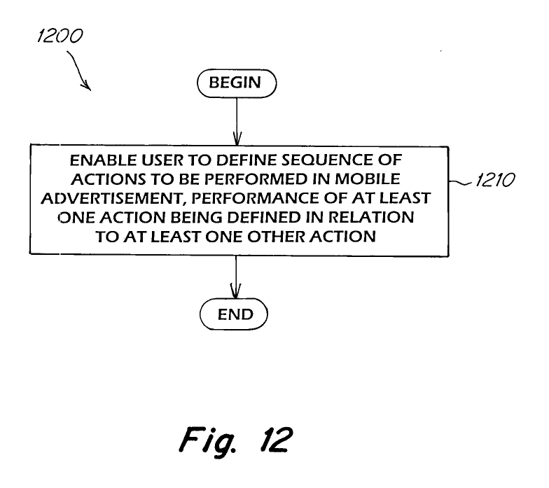

In some embodiments of the invention, a user may define a sequence of actions to be performed without the use of a timeline to specify when any individual action is to be initiated. For example, FIG. 12 depicts an example process 1200 which may be performed by a content development and management platform to enable a user to define a sequence of actions without use of a timeline. Example process 1200 begins in act 1210, wherein a user is enabled to define a sequence comprising a plurality of actions to be performed within a mobile advertisement, wherein performance of at least one of the actions is defined in relation at least one other of the plurality of actions being performed.

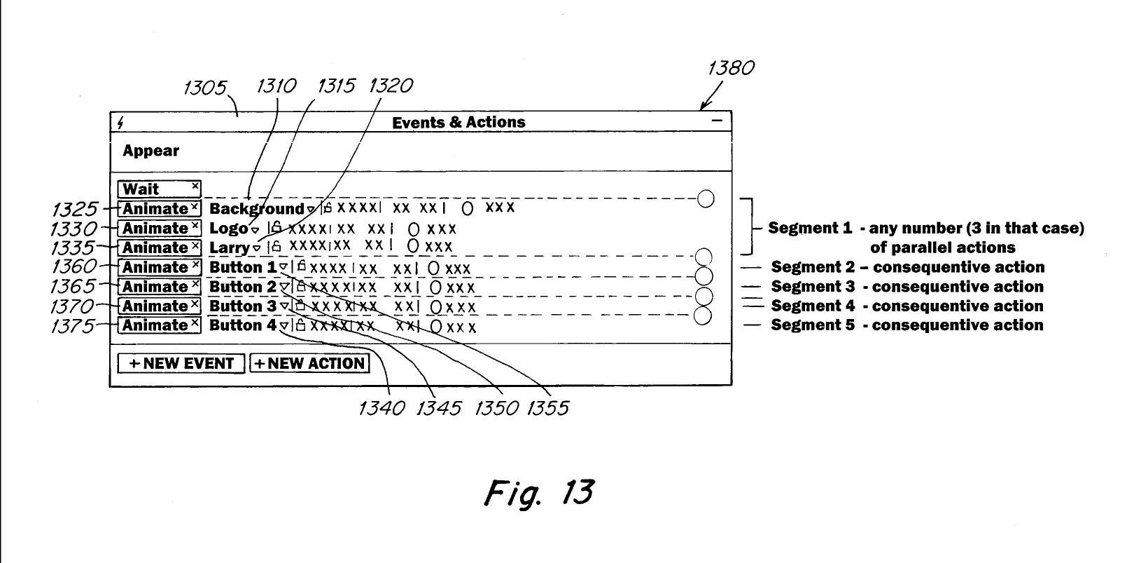

Act 1210 may be performed in any of numerous ways. For example, FIG. 13 depicts example menu 1305, which enables a user to define the initiation of a particular action in relation to one or more other actions being performed, rather than in relation to a timeline. In this example, actions involves animation of items of content within a mobile advertisement.

In the example shown, the user employed menu 1305 to define a first set of actions to occur in parallel, and a second set to occur sequentially. Specifically, actions 1325, 1330 and 1335 are specified to be performed in parallel to “animate” (as reflected via indicators 1325, 1330 and 1335) the “background,” “logo,” and “Larry” items (as indicated at portions 1310, 1315 and 1320, respectively) in parallel.

In the example shown, the user indicates whether an action is to occur after another (in this example, preceding) action or in parallel with that action via the clock control within menu 1305, indicated at 1380. By activating the clock control in relation to action 1325 but deactivating the clock control in relation to actions 1330 and 1335, the user indicates that actions 1325, 1330 and 1335 are to be performed in parallel. As a result, the background, logo, and “Larry” image are animated simultaneously on the mobile advertisement. By contrast, by activating the clock control in relation to each of actions 1360, 1365, 1370 and 1375, the user indicates that each of these actions are to be performed sequentially. As a result, “button 1,” “button 2,” “button 3,” and “button 4” (i.e., as indicated at portions 1355, 1350, 1345 and 1340, respectively) appear within (e.g., move to a designated location on) the mobile advertisement in sequence.

In the example shown in FIG. 13, the initiation of an action is defined in relation to the performance of another action. For example, selections made by the user on menu 1305 indicate that action 1365 is to be initiated upon the completion of action 1360. Of course, embodiments of the invention are not limited to such an implementation, as the performance of actions can be defined in any suitable manner. If the performance of one action is defined to occur in relation to the performance of another action, then performance may be defined to occur in any suitable fashion. For example, one action can be defined to start a specified period after another action completes, to begin a specified period before the other action completes, to end at the same time as the other action, or to be performed in any other suitable manner in relation to the performance of another action. However, the performance of one action need not be defined to occur in relation to the performance of another action, as any suitable technique(s) for defining a sequence of actions may be employed.

It should be appreciated that enabling a sequence of actions to be defined without use of a timeline allows the user to define a sequence much more quickly and easily than conventional tools and approaches allow. For example, rather than having to write code specifying that “when the time on the timeline is 3 seconds, perform this first action, and when the time on the timeline is 7 seconds, perform this second action, etc.,” as an example, a user employing embodiments of the invention may take advantage of a far simpler and more intuitive tool and approach. This not only allows the user to initially establish a sequence of actions, but then to also rearrange the sequence easily, without having to write or edit code. In this respect, it should also be appreciated that while conventional tools and approaches may afford a user much greater control over how sequences of actions unfold, and provide the ability to create more complex sequences of actions, mobile advertisements typically do not include such complex sequences, owing at least partially to the nature of the mobile medium. Generally, advertisers and advertising agencies seek to build relatively simple sequences that are interesting and engaging for the viewer, but do not exceed his/her cognitive load, given that a person viewing an advertisement on a mobile device is often primarily occupied with another activity (e.g., driving, walking, etc.). As a result, many creators of mobile advertising content do not need the ability to build complicated sequences like more robust tools allow. Rather, they find value in a tool which enables non-technical users to quickly and easily develop mobile advertisement content that is engaging without being overwhelming.

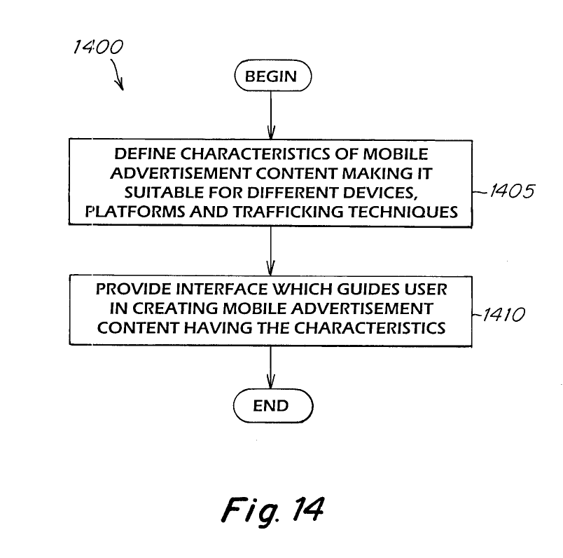

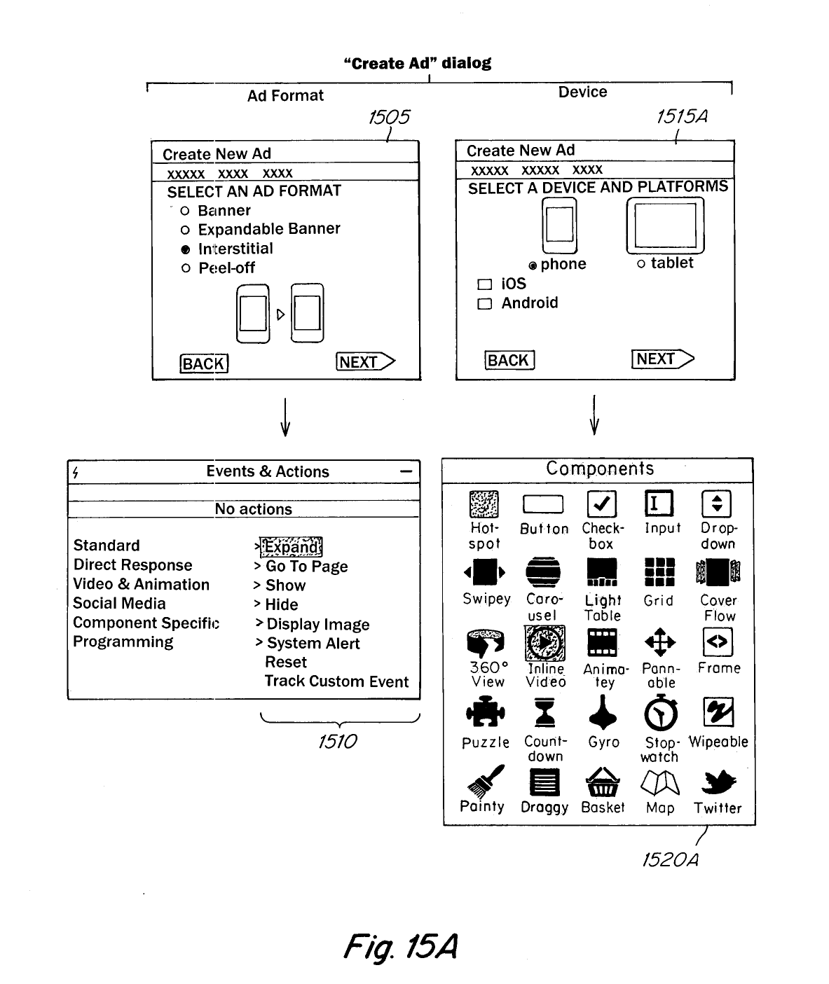

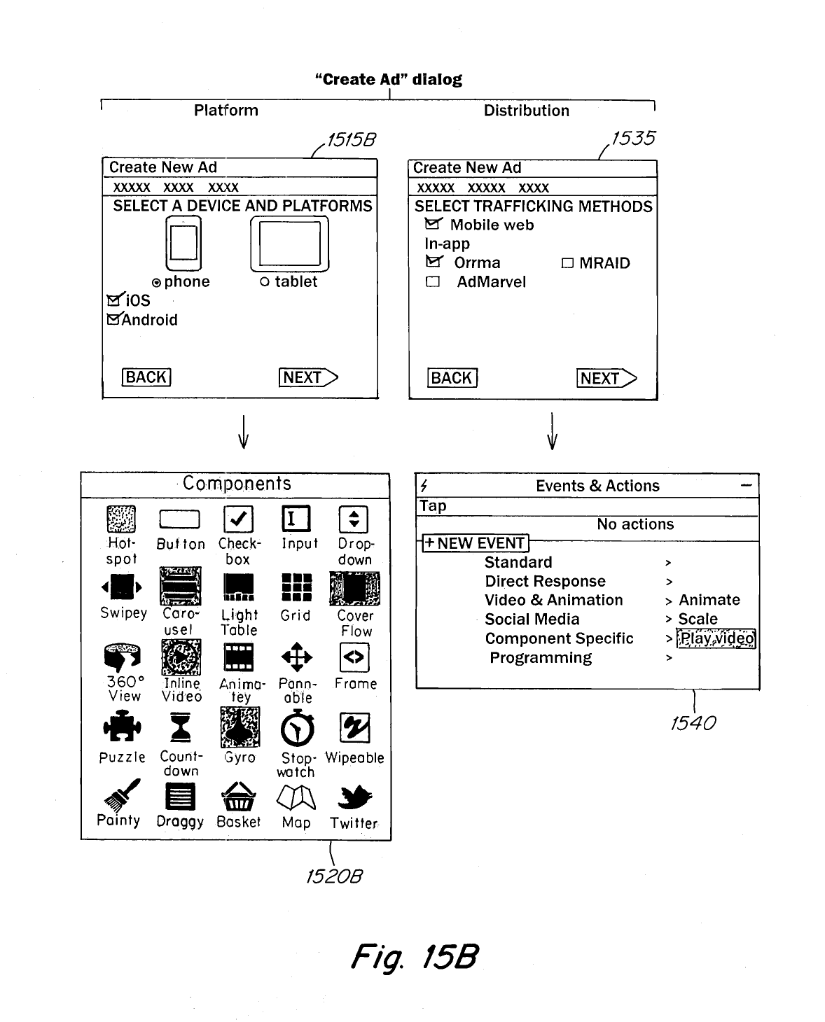

Some embodiments of the invention may provide a guide for the user to ensure that the mobile advertisement content created by the user is suitable for display on any of a variety of different mobile devices, for execution under any of a variety of different mobile operating systems, and for distribution via any of a variety of different trafficking techniques. An example process 1400 performed by a content development and management platform to guide a user through the process of developing mobile advertisement content which possesses characteristics making it suitable for different devices, platforms and trafficking techniques is depicted in FIG. 14.

At the start of example process 1400, in act 1405, the characteristics of mobile advertisement content which make it suitable for different devices, platforms and trafficking techniques are defined. For example, a content development and management platform may define and/or store a set of rules specifying various characteristics of mobile advertising content which make that content “agnostic” with respect to the wide variety of devices, platforms and distribution infrastructure with which it may interoperate.

At the completion of act 1405, example process 1400 proceeds to act 1410, wherein an interface is provided which guides a user in creating mobile advertisement content having the characteristics defined in act 1405. This may be performed in any of numerous ways. An example interface is depicted conceptually in FIG. 15. For example, FIG. 15 shows facility 1505, which allows a user to specify the format for a planned mobile advertisement. In the example shown, the user may select from formats including “banner,” “expandable banner,” “interstitial,” and “peel-off,” although it should be appreciated that any suitable number of formats may be listed. When a user selects a particular format via facility 1505, some embodiments of the invention make certain events and/or actions unavailable for inclusion within the planned mobile advertisement. For example, given the user's selection of the “interstitial” format in menu 1505, the “expand” menu option in menu 1510 becomes unavailable (as indicated by its being grayed out).

Via facility 1515, a user may specify the device type(s) and platform(s) for which a planned mobile advertisement is intended. In the example labeled 1515A, the user has specified the “phone” device type, which causes the “Hotspot” and “Inline Video” options in menu 1520A to become unavailable (e.g., because these menu options refer to components which do not function properly on a phone device). In the example labeled 1515B, the user's further selection of the “iOS” and “Android” platforms causes the “Carousel,” “Coverflow” and “Gyro” options in menu 1520B to become unavailable (e.g., because these menu options refer to components for which the code does not execute properly under the specified mobile operating systems).

Via facility 1535, a user may specify a trafficking method for a mobile advertisement. In the example shown, the user has indicated that the mobile advertisement is to be distributed via “mobile web” and “In-app” via the “ormma.org” distributor. These selections cause the “play video” option shown in menu 1540 to become unavailable to the user.

It should be appreciated that allowing proliferation of a mobile advertisement which does not properly account for the capabilities of the wide variety of devices on which it may be displayed, for the requirements of the wide variety of platforms under which it may execute, and/or for the specifics of the trafficking technique(s) and/or infrastructure by which it will be distributed can result not only in a “broken” advertisement that does not display properly, but also significantly detract from an ad campaign's return on investment, and have an adverse effect on a viewer's opinion of the advertiser (which is exactly contrary to reason for creating the mobile advertisement). By ensuring that a mobile advertisement has the characteristics to make it agnostic with respect to the many components of the mobile advertising ecosystem, embodiments of the invention provide safeguards which help prevent the proliferation of “broken” advertisements, and thus these undesirable side effects.

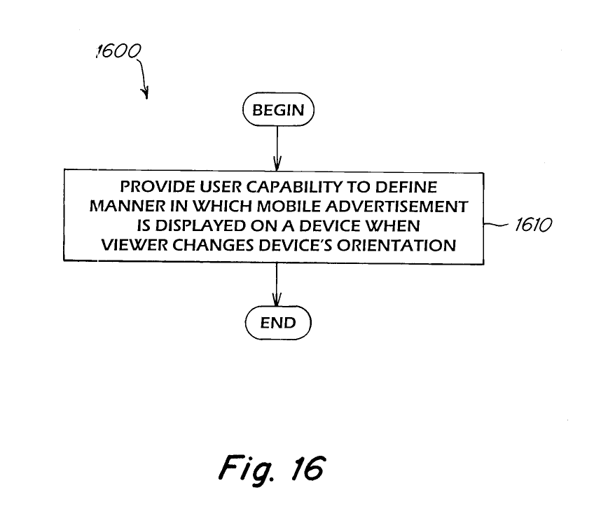

Some embodiments of the invention enable a user to specify the behavior of a mobile advertisement when a viewer changes the orientation of the mobile device on which it is viewed. FIG. 16 depicts an example process 1600 which may be performed by a content development and management platform to provide this capability. At the start of example process 1600, in act 1610, a user is provided a capability to define a manner in which a mobile advertisement is displayed on a device after a viewer changes the device's orientation.

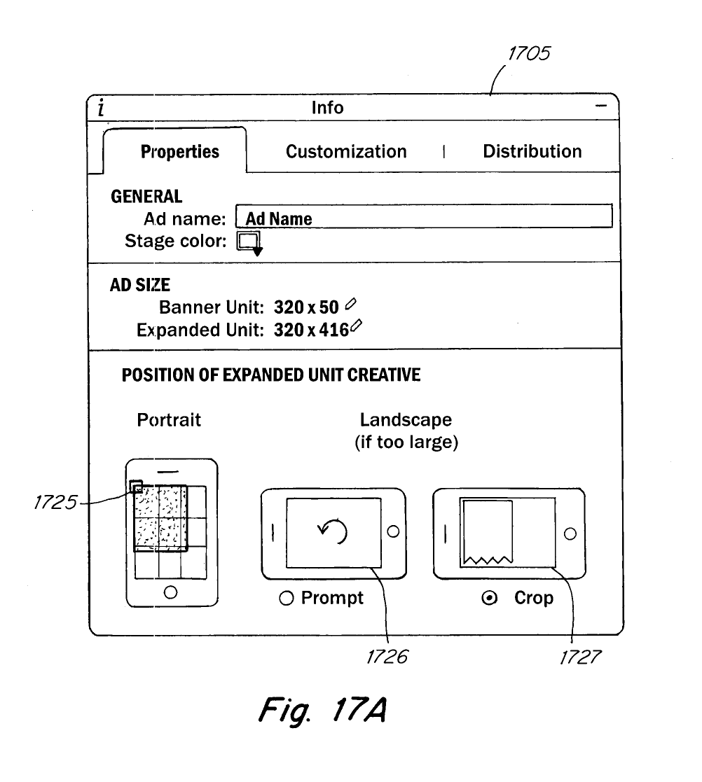

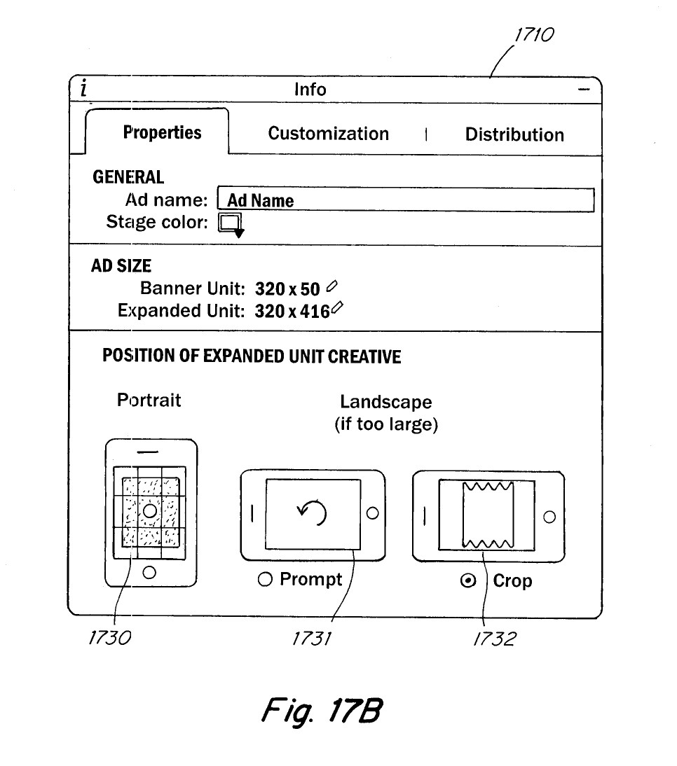

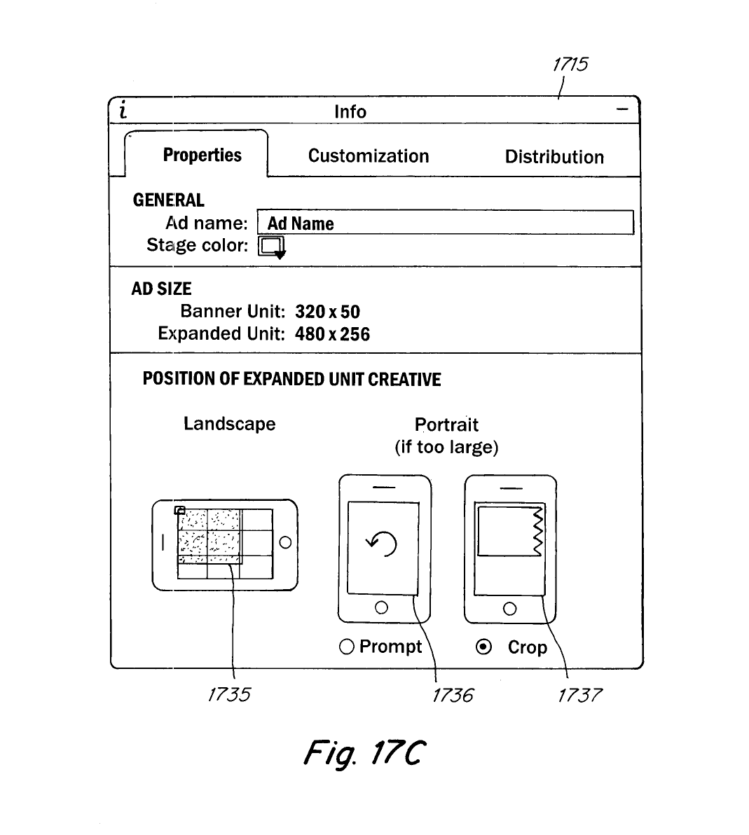

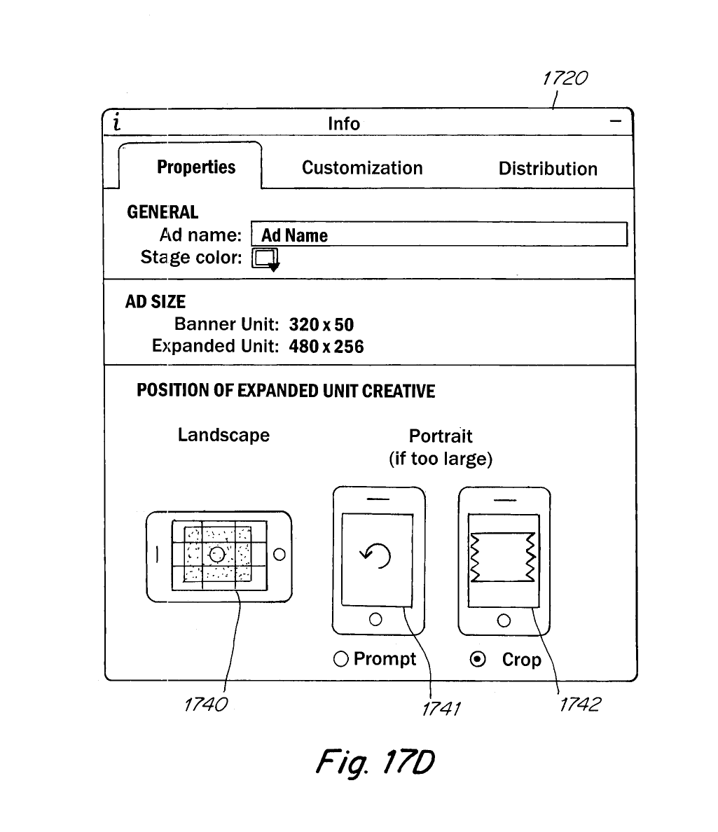

This may be performed in any of numerous ways. An example interface which provides this capability is shown in FIG. 17. In FIG. 17, menus 1705 and 1710 depict an example wherein a mobile advertisement includes a banner unit having a size 320×50 and an expanded unit having size 320×416. Given this size, the default orientation of the expanded unit is the “portrait” orientation. A user may specify that the expanded unit is aligned with respect to a top left corner of the display (as indicated via icon 725 in menu 1705), centered with respect to the display (as shown in icon 1730 in menu 1710), or has any other suitable alignment with respect to the display. Menus 1705 and 1710 also allow the user to define the behavior of the mobile advertisement if the user switches the device's orientation to “landscape.” In the examples shown, the user may indicate that the expanded unit is to be cropped (i.e., “Crop”) or that the user is to be prompted to switch back the device's orientation (i.e., “Prompt”). Of course, embodiments of the invention are not limited to allowing a user to select from only these two example behaviors. For example, in some embodiments, a user may specify that a particular image is to be displayed if the user switches the device's orientation, and/or specify other behavior(s).

Continuing with the above example, if the user indicates that the mobile advertisement is to be cropped, the user may specify that the expanded unit be aligned with the left side of the display screen (as shown in icon 1727 in menu 1705), with the center of the display screen (as shown in icon 1732 in menu 1710), or has any other suitable alignment with respect to the display screen.

Menus 1715 and 1720 depict an example wherein a mobile advertisement includes a banner unit having a size 320×50 and an expanded unit having size 480×256. Given the size of the expanded unit, its default orientation is the “landscape” orientation. A user may specify that the expanded unit is to be aligned with respect to a top left corner of the display (as indicated via icon 1736 in menu 1715), centered with respect to the display (as shown in icon 1740 in menu 1720), or has any other suitable alignment with respect to the display. Menus 1715 and 1720 also allow the user to define the behavior of the mobile advertisement if the user switches the device's orientation to “portrait,” including whether the expanded unit is to be cropped (i.e., “Crop”) or that the user is to be prompted to switch back the device's orientation (i.e., “Prompt”). If the user indicates that the mobile advertisement is to be cropped, the user may specify that the expanded unit be aligned with the top of the display screen (as shown in icon 1737 in menu 1715), with the center of the display screen (as shown in icon 1742 in menu 1720), or has any other suitable alignment with respect to the display screen.

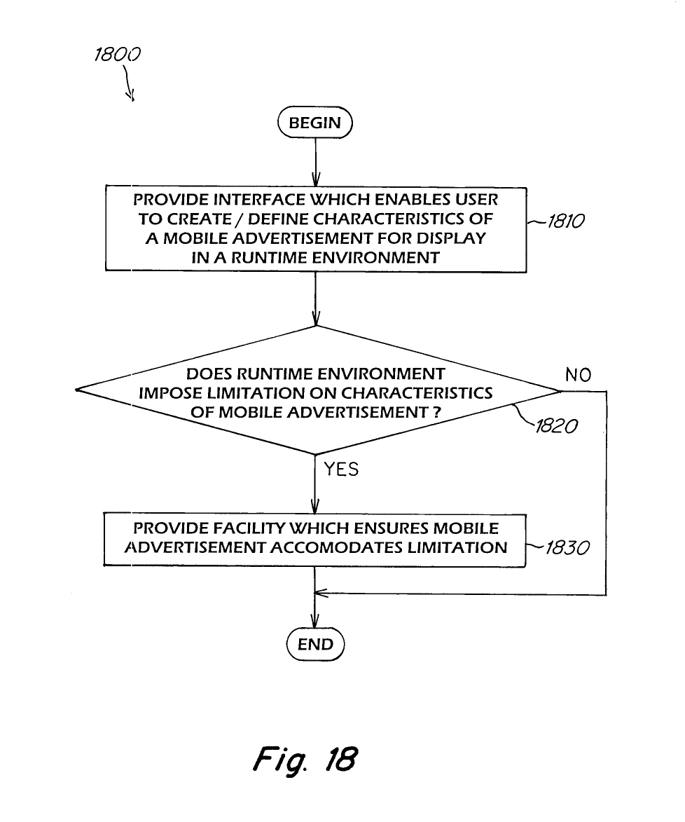

Some embodiments of the invention provide a capability whereby any limitations of a runtime environment in which a mobile advertisement may be shown may be properly accommodated. An example process 1800 which may be performed by a content development and management platform is shown in FIG. 18. At the start of example process 1800, in act 1810, an interface is provided which enables a user to create and define the characteristics of a mobile advertisement for display in a particular runtime environment. This may be performed in any of numerous ways, such as with any one or more of the example interfaces described above. In act 1820, a determination is made whether the runtime environment imposes a limitation on the characteristics of the mobile advertisement. If not, example process 1800 completes. However, if the runtime environment does impose a limitation on the characteristics of the mobile advertisement, then example process 1800 proceeds to act 1830, wherein a facility is provided which ensures that the mobile advertisement properly accommodates the limitation.

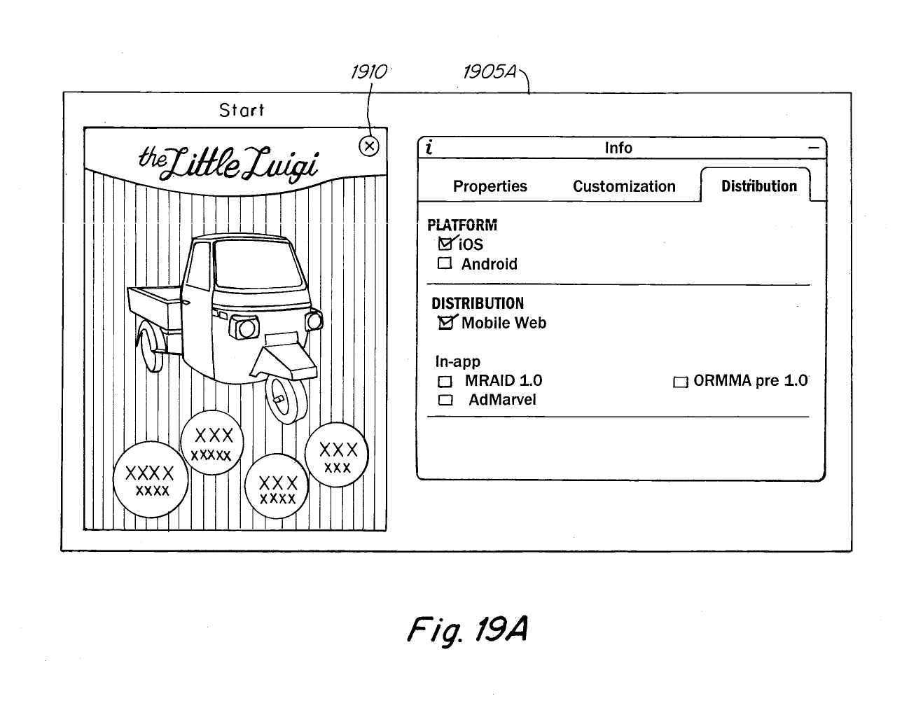

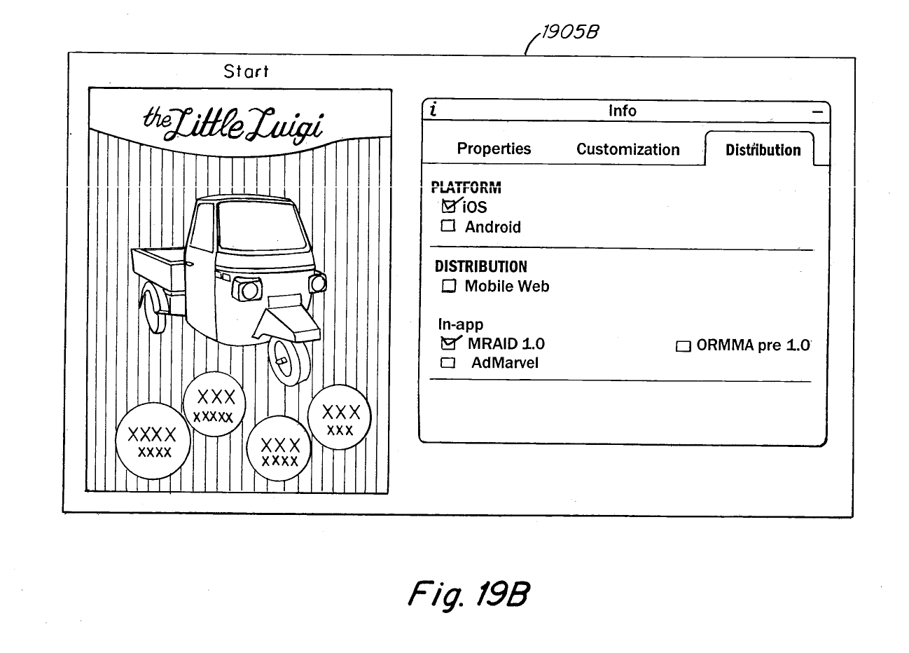

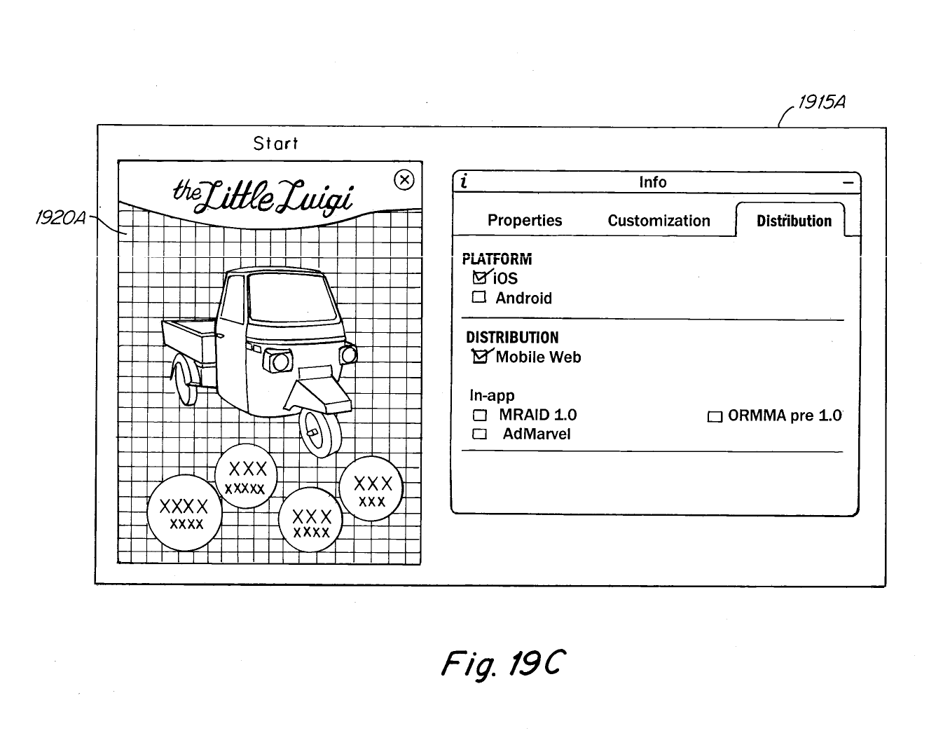

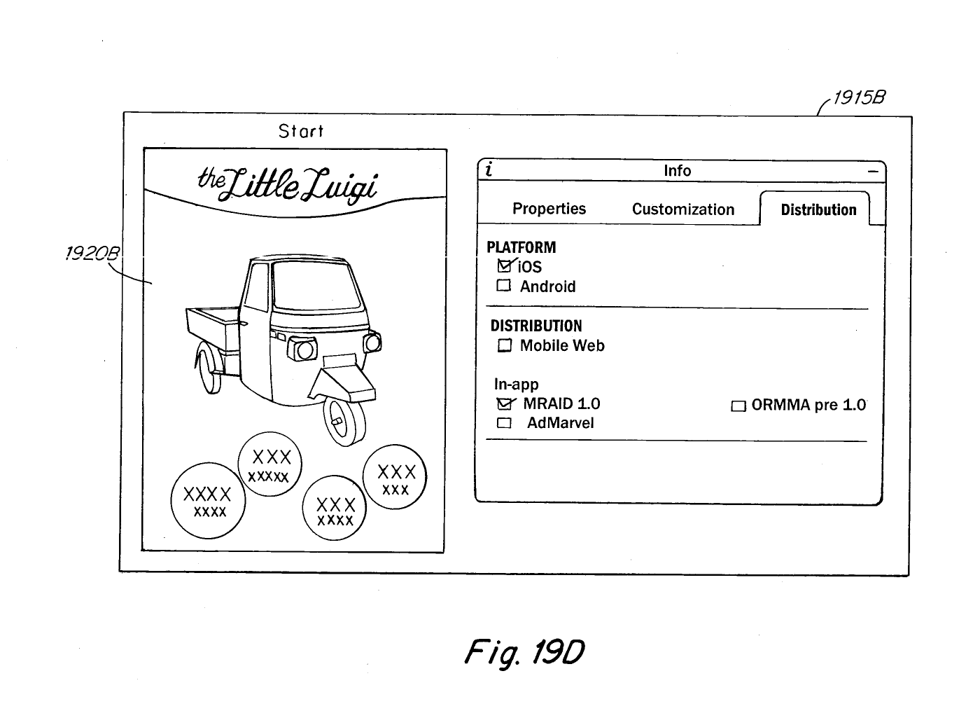

A facility which provides this capability may take any of numerous forms. FIG. 19 depicts example facilities which ensure that mobile advertisements accommodate limitations, such as predefined “close” buttons or predefined levels of transparency, imposed by certain runtime environments. Example facilities 1905A-1905B illustrate how embodiments of the invention may prevent a user from specifying the location of a “close” button if a particular runtime environment does not allow such a button to be specified by the user. Specifically, using example facility 1905A, the user has indicated that a mobile advertisement is to execute under the “iOS” mobile operating system and be distributed only via “Mobile Web” (i.e., not “In-app”). Because the specified runtime environment does not allow a user to specify the location of a “close” button, the facility dictates the close button's location via icon 1910, preventing the user from specifying its location. However, in facility 1905B, the user has indicated that a mobile advertisement is to execute under the “iOS” mobile operating system and be distributed “In-app” via “MRAID 1.0”. Because this runtime environment does not prevent a user from specifying the location of a “close” button, the facility does not dictate the button's location, allowing the user to do so.

Example facilities 1915A and 1915B ensure that mobile advertisements accommodate predefined levels of transparency imposed by certain runtime environments. Specifically, using example facility 1915A, the user has indicated that a mobile advertisement is to execute under the “iOS” mobile operating system and be distributed only via “Mobile Web.” Because this runtime environment imposes a first level of transparency, example facility 1915A displays the mobile advertisement with this level of transparency. In facility 1915B, however, the user has indicated that a mobile advertisement is to execute under the “iOS” mobile operating system and be distributed “In-app” via “MRAID 1.0”. Because this runtime environment imposes a second level of transparency, the mobile advertisement is displayed with this level of transparency.

It should be appreciated that although the examples given above are limited to the location of a close button and the level of transparency in a mobile advertisement, any of numerous types of runtime environment limitations may be accommodated, as embodiments of the invention are not limited in this respect.

In some embodiments, a content development and management platform is provided which generates code representing a mobile advertisement in a form which makes issue-free distribution and display more likely. For example, in some embodiments, a content development and management platform implemented in accordance with some embodiments of the invention may be configured to generate code (e.g., HTML5 code) which includes the content of a mobile advertisement in an “image” tag. As a result of the content being included within an image tag, the intended location for the mobile advertisement within a web page can be determined. In this respect, the inventors have appreciated that conventional approaches to including in a web page a script which, when executed by the browser, causes the mobile advertisement to be displayed within the web page (e.g., including the script as part of an HTML fragment to be inserted into the web page, providing Javascript code for execution by the browser which references the script, etc.) suffer from various deficiencies. These deficiencies may include not being able to have a script inserted at page load time or afterward without special treatment or modification of the web page. To overcome these and other deficiencies associated with conventional approaches, some embodiments of the invention provide a technique whereby a script is included within an image tag. An example image tag is given below:

```
<img src=“data:image/png,celtra” style=“display: none” onerror=“
  (function(img) {
    var req = document.createElement(‘script’);
    req.id = ‘celtra-’+(Math.random( )+‘’).slice(2);
    req.src = ‘http://ad-server/ad.js&scriptId=’+req.id;
    img.parentNode.insertBefore(req, img.nextSibling);
  })(this);
”>
```

When an image tag such as the example above includes a reference to a script to display a mobile advertisement, when the image tag is inserted into the web page, the browser attempts to load the image referenced by the data URI (i.e., ‘src=“data:image/png,celtra”’), without an additional request to the server. This operation fails, because the image is not a valid image, and so the browser executes the “onerror” handler (i.e., ‘onerror=” . . . ’). The onerror handler includes a reference to the image tag (i.e., ‘function(img)’), and therefore to the position within the web page where the mobile advertisement is to be displayed. The browser executes the referenced script, thereby causing the execution result (i.e., the mobile advertisement) to be displayed at the referenced position. Using this technique, some embodiments of the invention overcome deficiencies associated with conventional approaches, and enable the intended location of a mobile advertisement within a web page to be determined without issue.

Having thus described several aspects of at least one embodiment of this invention, it is to be appreciated that various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

The above-described embodiments of the present invention can be implemented in any of numerous ways. For example, the embodiments may be implemented using hardware, software or a combination thereof. When implemented in software, the software code can be executed on any suitable processor or collection of processors, whether provided in a single computer or distributed among multiple computers. Such processors may be implemented as integrated circuits, with one or more processors in an integrated circuit component. Though, a processor may be implemented using circuitry in any suitable format.

Further, it should be appreciated that a computer may be embodied in any of a number of forms, such as a rack-mounted computer, a desktop computer, a laptop computer, or a tablet computer. Additionally, a computer may be embedded in a device not generally regarded as a computer but with suitable processing capabilities, including a Personal Digital Assistant (PDA), a smart phone, cell phone or any other suitable portable or fixed electronic device.

Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, the invention may be embodied as a computer readable storage medium (or multiple computer readable media) (e.g., a computer memory, one or more floppy discs, compact discs (CD), optical discs, digital video disks (DVD), magnetic tapes, flash memories, circuit configurations in Field Programmable Gate Arrays or other semiconductor devices, or other non-transitory, tangible computer storage medium) encoded with one or more programs that, when executed on one or more computers or other processors, perform methods that implement the various embodiments of the invention discussed above. The computer readable storage medium or media can be transportable, such that the program or programs stored thereon can be loaded onto one or more different computers or other processors to implement various aspects of the present invention as discussed above. As used herein, the term “non-transitory computer-readable storage medium” encompasses only a computer-readable medium that can be considered to be a manufacture (i.e., article of manufacture) or a machine. Alternatively or additionally, the invention may be embodied as a computer readable medium other than a computer-readable storage medium, such as a propagating signal.

The terms “program” or “software” are used herein in a generic sense to refer to any type of computer code or set of computer-executable instructions that can be employed to program a computer or other processor to implement various aspects of the present invention as discussed above. Additionally, it should be appreciated that one or more computer programs that when executed perform methods of the present invention need not reside on a single computer or processor, but may be distributed in a modular fashion amongst a number of different computers or processors to implement various aspects of the present invention.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that conveys relationship between the fields. However, any suitable mechanism may be used to establish a relationship between information in fields of a data structure, including through the use of pointers, tags or other mechanisms that establish relationship between data elements.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the invention may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

What is claimed is:

1. A method for use in a computer system comprising a display device and at least one processor, the method being for facilitating creation of an advertisement for display on a mobile device, the method comprising acts of:
(A) causing a graphical interface to be displayed to a user via the display device, the graphical interface being operable to receive input from the user defining a manner of display of the advertisement on the mobile device;
(B) receiving input from the user specifying (1) an event and (2) an action to be performed in relation to at least one item of content included in the advertisement upon an occurrence of the event, wherein the event relates to at least one of initial display of the advertisement to a viewer via the mobile device, receipt of a defined form of input by a viewer of the advertisement to the mobile device, and an absence of input by a viewer of the advertisement to the mobile device over a specified time period; and
(C) processing, by the at least one processor, the input received in the act (B) to generate code representing the advertisement.

2. The method of claim 1, wherein the input specifies a plurality of actions to be performed in relation to at least one item of content included in the advertisement upon occurrence of an event.

3. The method of claim 1, wherein the action comprises an animation of at least one item of content included in the advertisement.

4. The method of claim 1, wherein the act (B) comprises receiving user input specifying a plurality of events.

5. The method of claim 1, wherein an event specified by the user comprises an event in relation to at least one of a page of the advertisement, an item of content included in the advertisement, or a component included in the advertisement.

6. A method for use in a computer system comprising a display device and at least one processor, the method being for facilitating creation of an advertisement for display on a mobile device, the method comprising acts of:
(A) receiving input from a user via a graphical interface presented on the display device, the input defining a plurality of components for inclusion in the advertisement, each of the plurality of components providing functionality with which a viewer of the advertisement interacts;
(B) receiving input from the user via the graphical interface specifying (1) an input from the viewer of the advertisement in relation to a first of the plurality of components, and (2) a manner in which a second of the plurality of components is to behave in response to the viewer's input being received; and
(C) processing, by the at least one processor, the input received in the acts (A) and (B) to generate code representing the advertisement.

7. The method of claim 6, wherein the act (A) further comprises receiving input defining a particular component providing functionality with which a viewer does not interact, and the act (B) comprises receiving input specifying a manner in which the particular component is to behave in response to viewer input being received in relation to the first component.

8. A method for use in a computer system comprising a display device and at least one processor, the method being for facilitating creation of an advertisement for display on a mobile device, the method comprising acts of:
(A) receiving input from a user via a graphical interface presented on the display device, the input defining a sequence of actions to be performed in relation to one or more items of content within the advertisement, wherein performance of at least one of the actions in the sequence is defined in relation to performance of at least one other of the actions in the sequence; and
(B) processing, by the at least one processor, the input received in the act (A) to generate code representing the advertisement.

9. The method of claim 8, wherein an initiation of the at least one of the actions is defined in relation to performance of the at least one other action.

10. The method of claim 9, wherein the initiation of the at least one of the actions is defined in relation to completion of the at least one other action.

11. The method of claim 8, wherein the act (A) comprises defining performance of at least one of the actions in the sequence in parallel with performance of at least one other of the actions.

12. (canceled)

13. The method of claim 6, wherein the act (B) comprises receiving input defining how information displayed by the another of the plurality of components is to change, causes the another of the plurality of components to start or stop performing one or more functions, or causes the another of the plurality of components to cease responding to user input.

14. At least one non-transitory computer-readable medium having instructions recorded thereon which, when executed, perform a method of facilitating creation of an advertisement for display on a mobile device, the method comprising acts of:
(A) causing a graphical interface to be displayed to a user, the graphical interface being operable to receive input from the user defining a manner of display of the advertisement on the mobile device;
(B) receiving input, from the user via the graphical interface, specifying (1) an event and (2) an action to be performed in relation to at least one item of content included in the advertisement upon an occurrence of the event, wherein the event relates to at least one of initial display of the advertisement to a viewer via the mobile device, receipt of a defined form of input by a viewer of the advertisement to the mobile device, and an absence of input by a viewer of the advertisement to the mobile device over a specified time period; and
(C) processing the input received in the act (B) to generate code representing the advertisement.

15. The at least one non-transitory computer-readable medium of claim 14, wherein the input specifies a plurality of actions to be performed in relation to at least one item of content included in the advertisement upon occurrence of an event.

16. The at least one non-transitory computer-readable medium of claim 14, wherein an event specified by the user comprises an event in relation to at least one of a page of the advertisement, an item of content included in the advertisement, or a component included in the advertisement.

17. At least one non-transitory computer-readable medium having instructions recorded thereon which, when executed, perform a method of facilitating creation of an advertisement for display on a mobile device, the method comprising acts of:
(A) receiving input from a user defining a plurality of components for inclusion in the advertisement, each of the plurality of components providing functionality with which a viewer of the advertisement interacts;
(B) receiving input from the user specifying (l) an input from the viewer of the advertisement in relation to a first of the plurality of components, and (2) a manner in which a second of the plurality of components is to behave in response to the viewer's input being received; and
(C) processing, by the at least one processor, the input received in the acts (A) and (B) to generate code representing the advertisement.

18. The at least one non-transitory computer-readable medium of claim 17, wherein the act (A) comprises receiving input defining a particular component providing functionality with which a viewer does not interact, and the act (B) comprises receiving input specifying a manner in which the particular component is to behave in response to viewer input being received in relation to the first component.

19. (canceled)

20. The at least one non-transitory computer-readable medium of claim 17, wherein the act (B) comprises receiving input defining how information displayed by the another of the plurality of components is to change, causes the another of the plurality of components to start or stop performing one or more functions, or causes the another of the plurality of components to cease responding to user input.

21. At least one non-transitory computer-readable medium having instructions recorded thereon which, when executed, perform a method of facilitating creation of an advertisement for display on a mobile device, the method comprising acts of:
(A) receiving input from a user defining a sequence of actions to be performed in relation to one or more items of content within the advertisement, wherein performance of at least one of the actions in the sequence is defined in relation to performance of at least one other of the actions in the sequence; and
(B) processing the input received in the act (A) to generate code representing the advertisement.

22. The at least one non-transitory computer-readable medium of claim 21, wherein an initiation of the at least one of the actions is defined in relation to performance of the at least one other action.

23. The at least one non-transitory computer-readable medium of claim 22, wherein the initiation of the at least one of the actions is defined in relation to completion of the at least one other action.

24. The at least one non-transitory computer-readable medium of claim 21, wherein the act (A) comprises defining performance of at least one of the actions in the sequence in parallel with performance of at least one other of the actions.
